(19) United States
(12) Patent Application Publication
(10) Pub. No.: US 2003/0093585 A1
(43) Pub. Date: May 15, 2003

(54) System and method for providing real-time information to a web browser

(76) Inventor: Stanley Allan, North York (CA)

Correspondence Address: FASKEN MARTINEAU DuMOULIN LLP, Toronto Dominion Bank Tower, P.O. Box 20, Suite 4200, Toronto-Dominion Centre, Toronto, ON, M5K 1N6, CA

(21) Appl. No.: 10/226,119

(22) Filed: Aug. 23, 2002

Related U.S. Application Data
(63) Continuation of application No. PCT/CA01/00219, filed on Feb. 23, 2001.

(30) Foreign Application Priority Data
Feb. 23, 2000 (CA) 2,299,150

(51) Int. Cl. G06F 9/46

(52) U.S. Cl. 709/330

(57) ABSTRACT

A web browser having hidden frames to transfer events and receive page updates. In order to improve performance multiple updates are streamed into a single frame as a single ongoing HTTP response. In one aspect of the invention, there is included in each update certain script code that is dynamically executed after the update is received, transferring control to an update routine, thus providing real time multiplexing over a single HTTP response.

The present invention relates to the field of data communications and in particular to a system and method for providing real time updates from a host system to a web based client.

### BACKGROUND OF THE INVENTION

The growth of the Internet can be attributed to popularity of the World Wide Web (“the Web”). The Web is actually an application program which runs on individual computers and that creates connections to multiple different host computers over one or more networks. Most Web computer files are formatted using Hypertext Markup Language (HTML) and Web communication among computers occurs using the Hypertext Transfer Protocol (HTTP). A computer file formatted in HTML is generally referred to as a “web page”.

Application programs generally known as Web browsers, such as Internet Explorer™ by Microsoft Corp., allows a file formatted in HTML/HT format (i.e. “web pages”) to be displayed on a computer screen. The web pages are displayed as a collection of text, images, sound, or other visual objects, which can appear as highlighted texts or graphics Furthermore, modem browsers have additional embedded applications, which are automatically activated when needed. Examples of such embedded applications include File Transfer Protocol (FTP) for transferring files, Gopher for remotely viewing files on another system, and Telnet for remotely accessing computer systems. Web browsers thus provide a powerful graphical environment for accessing information and communicating between networked computers.

The Hypertext Transfer Protocol (HTTP) is the set of rules for exchanging files (text, graphic images, sound, video, and other multimedia files) on the Web. Relative to the TCP/IP suite of protocols (which are the basis for information exchange on the Internet), HTTP is an application protocol. Essential concepts that are part of HTTP include the idea that files can contain references to other files whose selection will client additional transfer requests. Any Web server machine contains, in addition to the HTML and other files it can serve, an HTTP daemon. A daemon is a program that is designed to wait for and service HTTP requests.

The Web browser is an HTTP client, sending requests to server machines. When the browser user enters file requests by either “opening” a Web file by typing in a Uniform Resource Locator (URL) or clicking on a hypertext link, the browser builds an HTTP request and sends it to an Internet Protocol address indicated by the URL. The HTTP daemon in the destination server machine receives and processes the request and, returns the requested file.

Legacy back-end databases running computers, such as the IBM AS/400 were introduced prior to 1989, and hence pre-dated the Web and Internet revolution. In addition, such systems also antedated the open systems revolution that accompanied the Web/Internet revolution. Consequently, although these older system had a great deal of flexibility and networking capability built into them, much of the software written for them has been designed for the actual physical hardware of the system rather than being designed for conceptual network communication layers of present. Users have traditionally accessed these systems via actual, physical terminals, which are physically connected to and designed for the system.

The ubiquity of the modem personal computer has required that Internet/Web compatible machines be given the capability to replace the actual physical terminals connected to these legacy systems. The cost and risk to replace the legacy systems, particularly implementing new software for existing business rules is extremely high.

Telnet is a Transmission Control Protocol/internet protocol (TCP/IP) standard network virtual terminal protocol that is used for remote terminal connection service. Telnet allows a user at one site to interact with systems at other sites as if that user terminal were directly connected to computers at those other sites. Unfortunately, when designers attempted to implement the Telnet application to allow the newer machines to interact with the AS/400s, they found that standard Telnet was not adequate for the job.

One conventional method for providing a terminal session is to execute a terminal emulator application on a client system that is directly connected to a host legacy system using a TCP/IP socket connection. Another conventional method is to provide a connection through a web browser application by translating standard legacy data flows into HTML pages. However, such conventional web browser methods suffer from an inability to handle real-time host updates to user screens as well as other significant problems. For example, forms-based HTMI/TN3270 packages are unable to overcome a range of problems associated with common HTML implementations such as real-time host updates to user screens or finding a user's browser platform address on the network.

U.S. Pat. No. 5,754,830 ('830) describes an interface to legacy data flows, such as telnet (TN) data flows, across persistent TCP/IP socket connections to give users persistent bidirectional access to legacy host system data in terminal sessions, such as 3270, 5250, NVT and VT220 type terminal sessions. Terminal emulation is partially provided by applet executable code downloaded from a web/emulation server. The user can select the uniform resource locator (URL) of the legacy host system via a web browser package, and transparently receive the applet code, which is executed and invokes an appropriate terminal session.

Thus, users of the client system access to real-time legacy host system data and applications using a web browser The web/emulator server system converts standard legacy data flows into web/emulator data flows and vice versa permitting multi-session, multi-protocol access to legacy data and applications. The applet process converts the web/emulator data flows into a terminal session for display to the user. Essentially, the web/emulator server, client thread and applet process form a web browser terminal emulator providing a persistent bidirectional connection between the client system and the legacy host system. This system has disadvantages in that it may have browser Java compatibility problems and restrictions with the use of firewalls.

In general, there is a need for terminal emulators that are thin clients and which are (a) HTML-based for broad reach, ease of implementation and portability; (b) support real time host updates; and (c) provide Virtual Terminal emulation.

Java and ActiveX-based emulators as typically described in the '830 patent above, provide benefits (b) and (c), but not (a). These emulators will not function in network environments that prohibit Java™ or ActiveX™. Client machines require Java™ or ActiveX™ support. In many cases Java™ and ActiveX™ are not suitable for the Internet or even a corporate extranet. Conversely, current HTML-based emulators which provide benefit (a) do not provide benefits (b) and (c). Thus, host information can be lost, so the emulation is not complete.

It has been recognized that there is a need for an HTML gateway to these legacy or host systems because it provides ease of access and implementation. Other approaches require the installation of customer software onto the user's machine. This software may not be available for the user's operating system. It may take too long to download the application to the user's machine. The user may not want to install an unknown application for fear of it being a virus. The user may be behind a firewall that does not allow the application to be downloaded. There may be a corporate policy prohibiting the installation of unapproved applications. Users may not be allowed to install applications themselves, and the rollout time for a new application across a large site can be prohibitive. The training time for a new application is also a factor.

Furthermore for large Intranets, extranets, and the internet, where ease of access and broad reach are critical, a thin client solution is desirable. In a thin client solution one of the objectives is to reduce total cost of ownership through a solution that is easier to rollout and easier to maintain. Usually an application is not installed onto the user's machine since it is hard to rollout and maintain. Rather configuration files are stored on a server machine. The files are easier to change since they're in one place and not on ten thousand desktops.

The web is inherently page based. A browser is directed to a site and a page is returned. Clicking on a link or submitting a form results in a new page. Therefore, the Web may be described as a slide show as compared to a movie. Other HTML gateways use this request/response, page by page model. This is the standard web model. However, this is not typically how host applications work. Host applications can (a) update only a portion of the host screen and (b) update the host screen independent of user input. If the standard web model is applied then it is possible to (a) miss screen updates, (b) not display updates in real time when they truly occur, and (c) be unable to implement VT (UNIX applications), which is not request/response based on all.

To improve the experience by adding more interactivity, it is required to use active content. In order to achieve this, program code is embedded into a web page. When the page is loaded the browser runs the program. Depending upon browser security settings the program can modify the web page, connected to other servers, or even format a hard drive. There are basically two types of programs—(a) executable code such as ActiveX™ controls or Java™ applets, and (b) scripts such as JavaScript™.

Program code is a problem since this is just a web deployed application and has all the problems associated with applications. There are doubts as to whether it will run on a given platform, whether it can get through a firewall, or whether it is desirable to install an application at all. It is possible that it will have a virus. Therefore, some corporate sites prohibit the use of Java™ or ActiveX™. Furthermore, many using the code typically requires some control or plug-in that has to be downloaded and installed.

Although code is avoided, it there is still a possibility to use script. There are two types of script, signed and unsigned. Signed scripts have additional capabilities. Although it is possible for signed scripts to format your hard drive, a user has to explicitly accept the script before the browser will execute it. “Signed” refers to the digital signature that is applied to a script. The signature reliably identifies the author of the script. So the user is effectively asked “Do you want to run this signed script from Corporation X that requires extra privileges?” Users and IT managers dislike signed scripts because they are a security risk. Also it is difficult to get signed scripts to run reliably (if at all) on all platforms.

There is a need for a system that can provide real time updates without the use of code or signed scripts.

### SUMMARY OF THE INVENTION

The invention seeks to provide an HTML-based system and method for presenting real time data updates from a server. In accordance with this invention there is provided a web browser having hidden frames to transfer events and receive page updates. In order to improve performance multiple updates are streamed into a single frame as a single ongoing HTTP response. In one aspect of the invention, there is included in each update certain script code that is dynamically executed after the update is received, transferring control to an update routine, thus providing real time multiplexing over a single HTTP response.

### BRIEF DESCRIPTION OF THE DRAWINGS

The present invention will now be described by way of example only, with reference to the following drawings in which:

FIG. 1 is a schematic diagram illustrating a data processing system in which the methods and apparatus of the present invention may be embodied;

FIG. 2 is a schematic diagram of an information update flow for the system in FIG. 1; and

FIG. 3 is a schematic diagram of an architecture used by the system of FIG. 1.

### DETAILED DESCRIPTION OF THE PREFERRED EMBODIMENTS

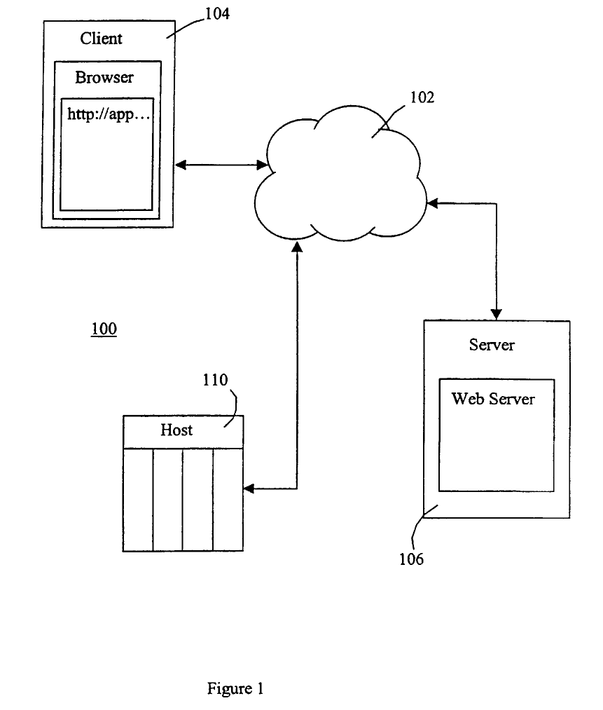

In the following description, like numerals will refer to like structures in the drawings. Referring to FIG. 1, there is shown generally by the numeral 100 a block diagram of a computer system in which the methods and apparatus of the present invention can be embodied. A network 102 includes a client or remote computer 104, e.g. a personal computer including such components as a central processing unit (CPU), a display and user input devices such as a keyboard and a mouse. The client computer 104 is coupled to a server 106 over the network 102, and possibly to a host computer 110. Those skilled in the art will appreciate that the client may take other forms than the personal computer illustrated. For example, the client computer may include a so-called “network computer”, i.e. a Web-enabled terminal with little or no local disk storage, or other computing device such as a personal digital assistant (PDA), personal communications system (PCS), or the like. Those skilled in the art will also appreciate that the server 106 may take various forms including conventional personal computer type servers or similar devices which may be addressable as locations in a network and have the capability to store information. Although the host computer 110 may take the form of a traditional mainframe computer running a conventional terminal application such as a 3270 application, those skilled in the art will appreciate that the host computer 104 may comprise various other apparatus that runs applications that conduct input and output using a terminal-type interface.

Furthermore, although the particular embodiment is described in relation to a client/server architecture, embodiments of the invention may be equally well applied to network systems used to provide a terminal interface to a host-based computer application from a remote terminal using terminal emulation information stored on a server external to the remote computer.

The client includes a web browse, which is frame enabled. Frames is the use of multiple, independently controllable sections on a Web presentation. This effect is achieved by building each section as a separate HTML file and having one “master” HTML file identify all of the sections. When a user requests a Web page that uses frames, the address requested is actually that of the “master” file that defines the frames; the result of the request is that multiple HTML files are returned, one for each visual section. Links in one frame can request another file that will appear in another (or the same) frame.

Using frames it is possible to present information in a more flexible and useful fashion. Each visual section, or frame, has several features. It can be given an individual URL, so it can load information independent of the other frames on the page. It can be given a NAME, allowing it to be targeted by other URLs. It can resize dynamically if the user changes the window's size. (Resizing can also be disabled, ensuring a constant frame size.)

These properties offer new possibilities. Elements that the user should always see, such as control bars, copyright notices, and title graphics can be placed in a static, individual frame. As the user navigates the site in “live” frames, the static frame's contents remain fixed, even though adjoining frames redraw. Table of contents (TOCs) are more functional. One frame can contain TOC links that, when clicked, display results in an adjoining frame. Frames “side-by-side” design allows queries to be posed and answered on the same page, with one frame holding the query form, and the other presenting the results.

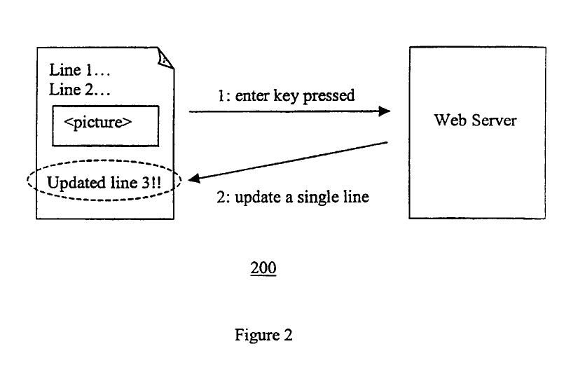

It is possible to use frames to remotely monitor web page events and dynamically modify web page content, as illustrated in FIG. 2 by the numeral 200. This is referred to as Remote Page Control (RPC). RPC uses hidden frames to transfer events and receive page updates. Only the changed content is transmitted across the network, and only the changed content is redisplayed. This yields sufficient performance to implement a wide range of HTML-based web applications, with a high level of responsiveness and interactively.

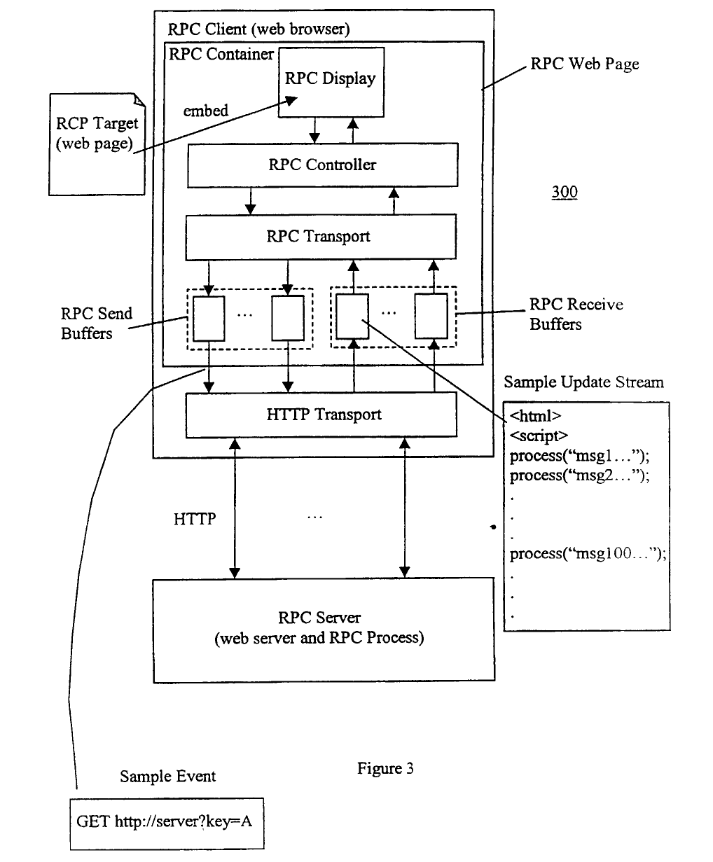

The RPC architecture, illustrated in FIG. 3 by the numeral 300, consists of the following components. An RPC Target is a given web page that is to be RPC-enabled. An RPC Web Page is an RPC-enabled web page, consisting of an RPC Container, RPC Display, RPC Controller and RPC Transport. An RPC Client is client side web browser or emulator that hosts the RPC web page. An RPC server is a server side component that receives events from multiple RPC web pages and issues updates to these pages. The RPC Container is a frameset web page that hosts the RPC target. The RPC Display is the RPC target embedded as a frame of the RPC container. The RPC Controller is script code that manages event dispatch and update processing. The RPC Transport is responsible for sending events and receiving updates. It also manages RPC send buffers and RPC receive buffers. The RPC Send Buffers are hidden frames of the RPC container that dispatch events to the RPC server process. The RPC Receive Buffers are hidden frames of the RPC container that receive updates from the RPC server process.

Event processing in an RPC web page operates as follows. An event is generated from the RPC display. An example of such an event is a key press event. Through an event binding defined by RPC container, the event is dispatched to the RPC controller. The RPC controller performs optional client side event filtering and processing. If the RPC controller determines the event should be sent to the RPC server then the event is passed to the RPC transport.

The RPC transport issues an HTTP GET or POST request to the next available RPC send buffer, where the request URL is the URL of the RPC server. In the case of an HTTP GET request the event is encoded in the query string of the request URL. In the case of an HTTP POST request the event is encoded in the body of the request. Optional sequencing or timestamp data can also be encoded. This allows the order or time sequence of the events to be preserved. Session information can also be included in the request.

The RPC server receives and decodes the HTTP GET or POST request. Events are sequenced as necessary, and server side event processing occurs. This may include RPC update processing, which is described below in greater detail. The RPC server sends an HTTP response to the RPC client. This will usually be a null response, and is required only to satisfy the HTTP protocol. However optional out of band data could be returned in the response.

Update processing in an RPC web page operates as follows. When an RPC container is initialized (loaded into an RPC client) the RPC controller requests the RPC transport to initialize itself. The RPC transport issues an HTTP GET request to an RPC receive buffer, where the request URL is the URL of the RPC server. The query string of the request URL encodes that this an initial request to establish a streaming update channel.

The RPC server receives and decodes the HTTP GET request, and determines that this is a request to establish an update connection. The RPC server keeps the request open, pending updates to the RPC web page. Client and server pings are used to prevent timeouts of the underlying TCP/IP connection. At some later point the RPC server may determine an update is necessary to the RPC web page in question. In this case the RPC server streams the update to the client within the ongoing HTTP response. The update includes script code that transfers control to the RPC transport immediately after the update is received by the RPC client.

The RPC client receives and processes the update. The RPC transport passes control to the RPC controller. The RPC controller uses available script APIs to dynamically update the RPC target as required by the update message. Additional updates are performed as required. To reclaim resources the RPC receive buffer is periodically flushed. In certain RPC clients this can be achieved with scripting APIs that will not terminate the update connection. Otherwise the RPC client can request the RPC server to send future updates to a newly created RPC receive buffer.

Upon receipt of this request the RPC server will complete the HTTP response to the original RPC receive buffer and begin to stream updates to the new buffer. When the RPC client receives the completed HTTP response it can delete the original buffer.

RPC pushes the envelop with unsigned scripts, making the script code do things previously unthinkable, such as allowing the web server to take a screen update from the host and push it to the browser, where the web page is dynamically modified to display the changed content.

An example of the above implementation is presented below for illustration.

The user wants to ran an order entry application. The user browses to a web page, http://www.server.com/OrderEntry.html either by typing in the URL, choosing a bookmark, or clicking a hyperlink on a page listing various corporate applications that are available. The web server delegates the request to a server process. The server process could be a CGI script, ASP process, Java servlet, etc. Any web server extension will suffice. Note the term “process” is used in a generic sense, not in the technical sense of a process created by an operating system.

The server process establishes a persistent connection to a certain host application, in this case the order entry application. The page request determines which host application to contact. The server process returns the OrderEntry.html web page to the browser. The OrderEntry.html web page may look something like:

<html>
<head>

<title>Order Entry Application</title>

</head>
<frameset rows=”*, 0, 0”>

<frame name=”Display” src=”about:blank”>
</frame>
<frame name =”SendBuffer” src=”about:blank”>
<frame>
<frame name=”ReceiveBuffer”src=
”http://www.Server.com/GetUpdates.html”>
</frame>

</frameset>
</html>

This page is a frameset document containing three frames, dividing the page into three rows. The first frame, the Display frame, is visible and is where an application will appear. This frame is initially blank. The second frame (SendBuffer) is hidden and is used to send user input to the web server. The third frame (ReceiveBuffer), is hidden and is used to receive screen updates. The technique of hidden frames is well known in the art and need not be described in further detail.

Since the ReceiveBuffer has a source URL the browser automatically requests the web page, http://www.server.com/GetUpdates.html, from the web server. The browser will load this web page into the ReceiveBuffer frame, but since the frame is hidden the web page will not be visible to the user.

Again, the web server delegates the request to the server process. The server process begins to return the GetUpdates.html web page to the browser, but does not finish the page. Initially all that is returned is the start of a generic HTML document:

<html>
<head>

<title>Update Stream</title>

</head>
<body>

Note this HTML page is not complete. It's missing </body>and </html> tags. The web browser receives the start of the GetUpdates.html page and keeps the connection to the web server open, waiting to receive the rest of the page. At some time later the application updates the host screen and sends an update message to the server process. For example, the host screen simply says “Hi Kevin, what's your order for today?”

The server process receives the host screen update and encodes it into the ongoing GetUpdate.html page response:

<script language=“JavaScript”>

process(“Hi Kevin, what's your order for today”);

</script>

Note the GetUpdate.html page is still not complete. The web browser is still loading the GetUpdate.html page, and receives the above HTML fragment. The script code is executed “on the fly”, and the process function is called.

In an actual application the process function can vary. It can be whatever makes sense for the application, the web browser, and the particular scripting language. For example for Internet Explorer we could use:

top.Display.document.body.innertext=“Hi Kevin, what's your order for today”;

which would update the Display frame with the specified text.

Repeat steps from the updating of the host screen with information to the presentation of the information on a user's screen as necessary in order to stream updates into the web page.

Therefore, it can be seen that RPC allows a web server to push arbitrary script code to a web browser, in real time, for a wide variety of applications.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A method for providing realtime updates in a web browser comprising the steps of:
(a) running a frame enabled web browser on a client computer;
(b) establishing an HTTP based connection between said web browser and a server; and
(c) providing at said server a process for multiplexing on said HITP connection data to be displayed on said browser.

2. A method for updating a client browser from a server, said method comprising the steps of:
(a) establishing an HTTP based connection between said web-browser and server computer; and
(b) keeping said HTTP connection open after an HTML page has been fetched, while fresh data is pushed to said client.
